(19) United States
(12) Patent Application Publication
(10) Pub. No.: US 2012/0187215 A1
(43) Pub. Date: Jul. 26, 2012

(54) PRESSURE WASHER CRUTCH

(76) Inventor: John Roy Kirkpatrick, Surrey (CA)

(21) Appl. No.: 13/439,142

(22) Filed: Apr. 4, 2012

Related U.S. Application Data
(63) Continuation of application No. PCT/CA2010/000093, filed on Jan. 22, 2010.
(60) Provisional application No. 61/249,299, filed on Oct. 7, 2009.

(51) Int. Cl. A62C 31/24; B23P 19/00

(52) U.S. Cl. 239/280; 29/700

(57) ABSTRACT

A crutch supports a pressure washer wand having a surface washing nozzle. The crutch has an elongate leg adapted to be removably secured along at least a portion of the wand and a free end of the leg extends away from the wand. A foot at the free end contacts the surface and supports the nozzle away from the surface. The foot may be mounted to slide along or roll along the surface. At least one fastener (e.g. hook and loop type) may be used to secure the crutch to the wand. The free end may be canted away from a longitudinal axis of the wand to avoid interfering with the nozzle. An extension member may extend the leg. At least one fastener may couple the leg and extension member. The foot may comprise a (partially) spherical body. The crutch may be provided as a kit.

### CROSS REFERENCE

This application is a continuation of PCT International Application PCT/CA2010/000093 filed Jan. 22, 2010 and which claims the benefit of earlier filed U.S. Provisional Patent Application No. 61/249,299 filed Oct. 7, 2009, the entireties of which are incorporated herein by reference.

### FIELD

The following relates generally to pressure washers, sometimes called power washers and more particularly to a support device for supporting the nozzle of the washer away from a surface to be washed.

### BACKGROUND

The pressure or power washer has become a tool used by the population at large to clean an assortment of surfaces such as those found on a deck, driveway, dock, boat, car, etc. Pressure washers provide a tremendous amount of power via the spray baton and are available in wide variety of power outputs that is further impacted by the type and configuration of the spray batons and directional nozzles. Further, the power generated can vary greatly by the engine pump's ability to produce a level of water flow known, typically measured as PSI (pounds per square inch), in this particular case, a measure of the strength of the spray coming out of the nozzle. To put it into perspective, a regular garden hose has a pressure of about 40 PSI, a low-end electric power washer is about 1000 to 1200 PSI and a high-end consumer gas model operates from 2800 to 3500 PSI. At the back end, power washers draw water from a source (usually an outdoor faucet, but it can be from a standing body like a pond or a lake) and, at the front end, pumps it through a nozzle at a much higher pressure than is available from regular sources such as a municipal water supply or an artesian well.

The wide variety of increased pressure available, coupled with any one of a number of specialized nozzle configurations, produces a spray that will simply wash a car or, in the more powerful modes, strip layers of paint off a wall or a deck. Concentrated water sprays can be made so powerful that, in certain industrial uses, they're used to cut through steel plate. Power washers may have PSI levels that range from 1000 to 5000+, batons and nozzles that range from wide soft spray to powerful osculating needle sprays, etc.

It has become a significant challenge to produce a high power device and still provide a safe environment for the non-professional “average” user from causing unintentional damage to the targeted cleaning surface due to the high power PSI available today. This challenge is particularly significant for some individuals that do not possess the physical strength to safely operate these powerful machines. This creates an unfortunate and risky situation of engaging in unintentional “proximity pressure” spray, causing damage to the target surface being cleaned or damage to the operator.

### SUMMARY

Accordingly, there is a need for a pressure washer crutch allowing for the attachment to any power sprayer in order to provide a physical safe stop. The crutch may be adjustable to suite multiple pressure washer PSI, baton or nozzle configurations. Such interface may transform the effective engagement using the pressure washer, increase flexibility, effectiveness, and user safety.

A crutch is provided for supporting a pressure washer wand having a nozzle for washing a surface. The crutch has an elongate leg adapted to be removably secured along at least a portion of a wand barrel such that the leg comprises a free end extending away from the barrel. A rounded foot (e.g. a sphere, partial sphere or other rounded shape body) is provided at the free end of the leg (e.g. for sliding or rolling contact with the surface) to support the nozzle away from the surface. The foot may be mounted for rotation, to roll along the surface. At least one fastener (e.g. hook and loop type) may be used to secure the crutch to the barrel. A portion of the crutch (e.g. a portion of the leg) may comprise a concave surface for securing along a convex surface of the barrel and at a position of choice 360° around the surface of the barrel. The free end may be canted away from a longitudinal axis of the barrel to avoid interfering with the nozzle. One or more extension members may extend the leg. The foot may be mounted to a free end of the one or more extension members. At least one fastener may couple the leg and extension member. The crutch may be provided as a kit.

These and other aspects will be apparent to persons of ordinary skill in the art.

### BRIEF DESCRIPTION OF THE DRAWINGS

The embodiments are more fully appreciated in connection with the following detailed description taken in conjunction with the accompanying drawings, in which:

FIG. 1 is a side view of a crutch mounted for supporting a pressure washer wand having a nozzle in accordance with one embodiment;

FIG. 2 is a side view of a crutch, comprising an extension member, mounted for supporting a pressure washer wand having a nozzle in accordance with another embodiment;

FIGS. 3A and 3B and 3C to 3E are side views of a crutch, comprising an extension member, mounted for supporting a pressure washer wand having a nozzle in accordance with respective embodiments;

FIG. 4A is a side view showing a supported wand in three representative positions;

FIG. 4B is a front view showing a supported wand in three representative positions;

FIGS. 5A and 5B are respective side views of leg portions of the crutch in accordance with various embodiments, FIGS. 5C to 5F are cross-sectional views thereof along the respective lines shown in FIGS. 5A and 5B;

FIGS. 6A and 6B are enlargements of respective embodiments of a foot portion secured to the crutch;

FIG. 7 is a side view of a crutch mounted for supporting a wand in accordance with the embodiment of FIG. 6B;

FIG. 8 is an enlarged view of an another embodiment of a foot portion, not mounted to the crutch;

FIGS. 9, 10A, 10B, 10C, 11 and 12 illustrate embodiments of the crutch in which the foot portion is mounted for rotation; and

FIGS. 13 and 14 illustrate a further embodiment showing a pair of crutches mounted opposite to one another.

Like reference numerals refer to corresponding parts throughout the several views of the drawings.

### DETAILED DESCRIPTION

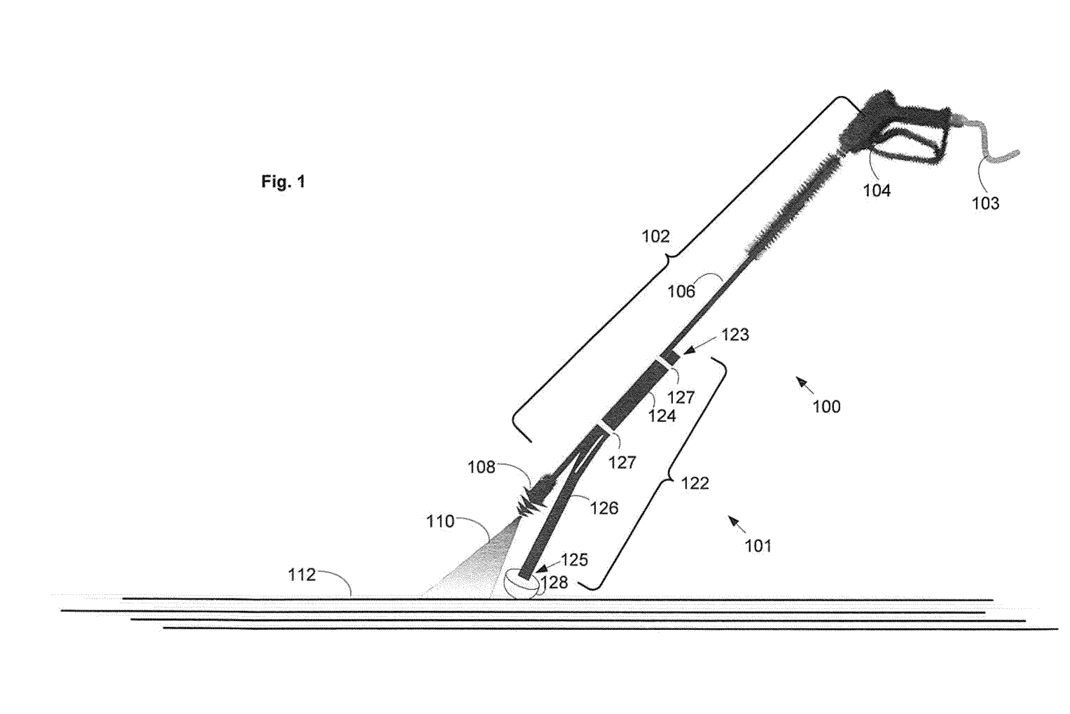

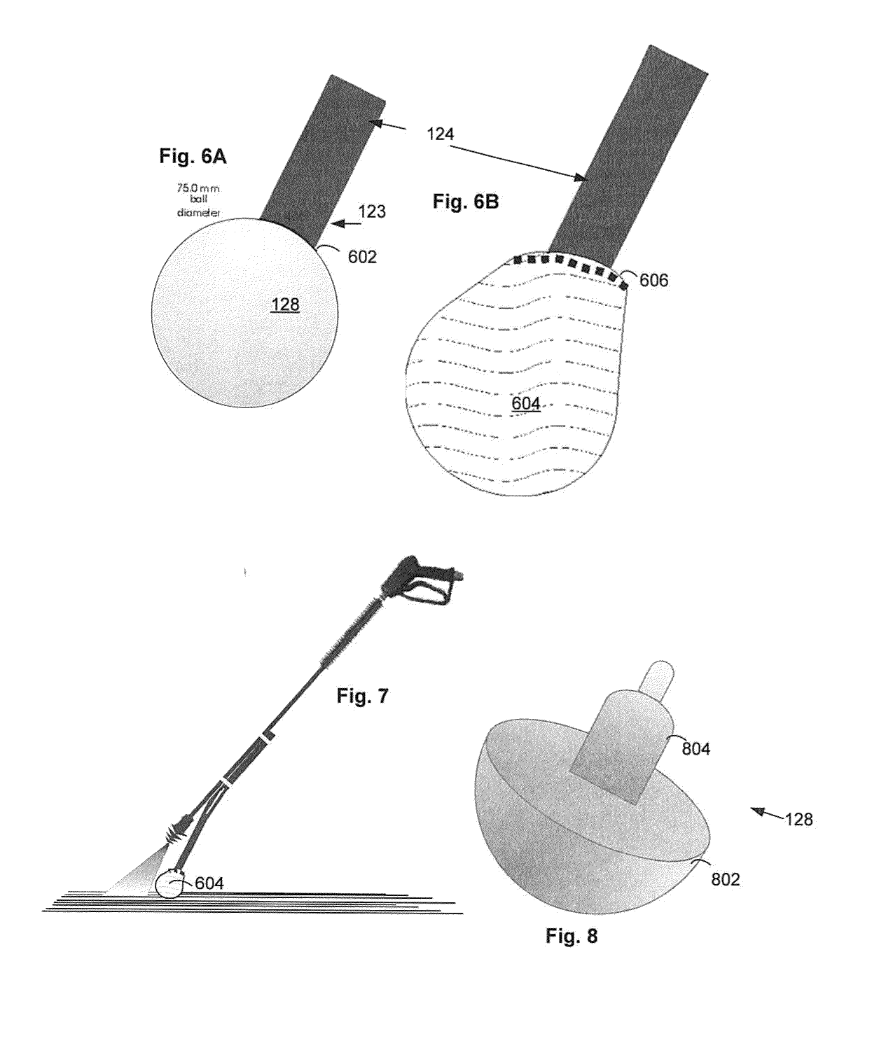

FIG. 1 is a side view 100 of a crutch 101 in accordance with one embodiment mounted for supporting a pressure washer wand 102 having a nozzle 108 for washing a surface 112 with a spray 110. It will be understood that the term “wand” as used herein is also commonly referenced as a “baton” or “lance”. Wand 102 may include a control handle 104. It is understood that in use wand 102 is connected, typically using a hose 103 to further components of a pressure washer such as a pump for delivering a fluid under pressure for producing stream 110. Crutch 101 may comprise an elongate leg 122 adapted to be removably secured along at least a portion of a barrel 106 of the pressure washer wand 102, such that when secured, said leg 122 and hence the crutch 101 comprises a free end (e.g. 125) extending away from the barrel 106. Crutch 102 may further comprise a foot 128 at the free end of the leg to support the nozzle away from the surface. In the present embodiment the foot is mounted to the leg for slidably contacting or otherwise riding along the surface to be washed. The foot 128 may be substantially rounded in a plurality of directions. Such a rounded foot may comprise a spherical shape (See FIG. 6A) a hemispherical or similar partial sphere (FIG. 1) or other similar shapes as further described herein below.

Leg 122 may be removably secured to the barrel using at least one hook and loop fastener 127. Other removable fastening means may be used, for example, a snap fit connector (not shown), clamp such as a worm drive hose clamp, (not shown), cable tie (not shown), among others. A hook and loop fastener typically comprises one or more strips having surfaces that mate to provide a secure but removable fastener. One surface usually comprises hooks and the other loops as is well known. Velcro® brand hook and loop fasteners are widely available. In some embodiments, a portion of a hook and loop fastener 127 may be fixed to the crutch and a mating portion fixed to the barrel 106. In other embodiments, a strip of hook and loop fastener may be secured to only one of the leg and the barrel for extending around the other for removably securing the crutch. The strip may include both hook and loop portions, possibly on opposite sides of the strip, for engaging one another when wrapped around. Hook and loop fasteners are easy and quick to assemble without tools. Such a strip may be completely removable from the barrel 106 and crutch 101 in some embodiments.

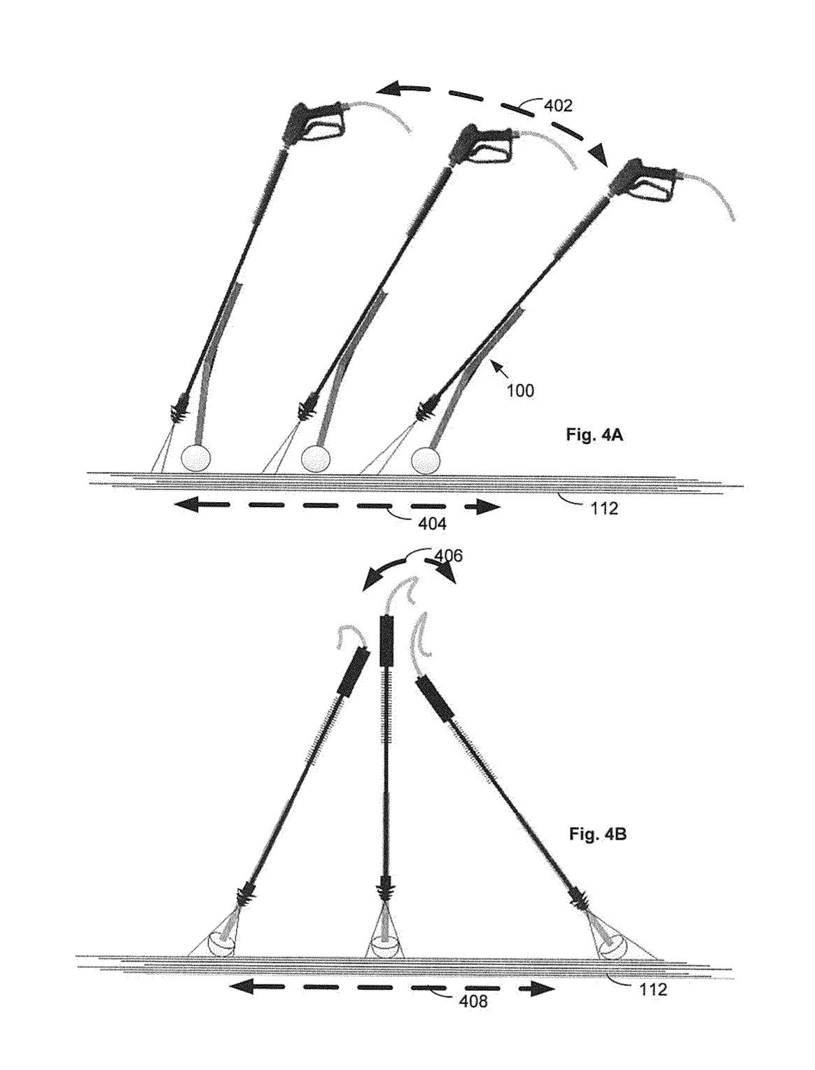

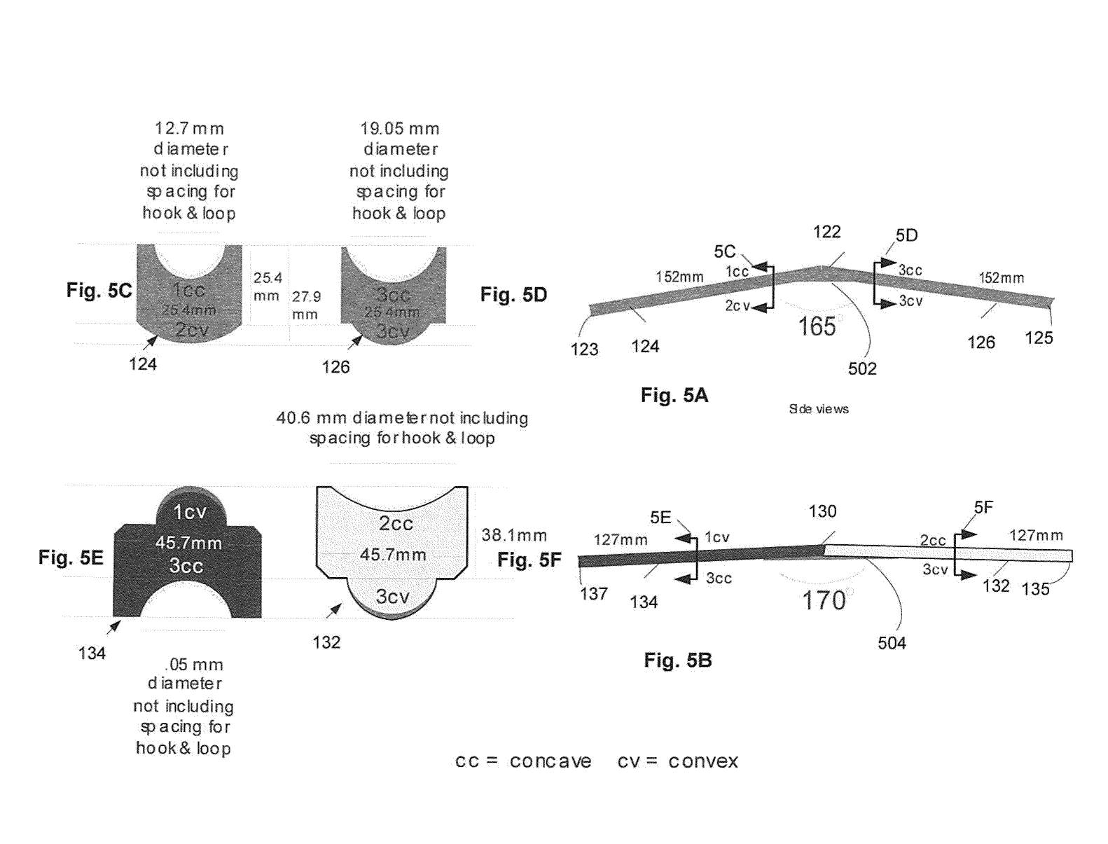

As described herein below, a portion of the leg may comprise a concave surface (e.g. a cradle portion) for securing along a convex surface of the barrel. The leg may be secured at a position of choice around the 360° surface of the barrel. For example, in FIG. 1, the concave surface of the leg is mounted to a back or rear portion of the barrel. A rear mount may be preferred when a majority of the power washing is accomplished by applying a forward and backward motion to the wand (along line 404 of FIG. 4A). In an alternative use embodiment, not shown, a left or right side mount may be preferred when a majority of the power washing is accomplished by applying a side to side motion to the wand. When the leg is secured to the barrel, a free end 125 is canted away from a longitudinal axis of the barrel (the axis running generally in the direction between the handle 104 and nozzle 108) to avoid interfering with the nozzle 108 and possibly its spray 110. To assist, the leg 122 may comprise a first elongate portion 124 and a second elongate portion 126 joined about respective ends in an angled relationship. Though shown in FIG. 1 with portion 124 mounted to the barrel, portion 126 may be mounted and portion 124 not mounted such that end 123 is free. Each portion 124, 126 may have differently sized concave surfaces for engaging barrels having different sized convex surfaces. See FIGS. 5A to 5F. Though portions 124 and 126 are illustrated in a fixed angled relationship, the first and second portions 124 and 126 may be connected in a manner that allows adjustment of the angle (e.g. by a pivot point that has a locking mechanism, not shown).

Though shown mounted generally to an underside/backside of barrel 106, crutch 101 may mount to a left or right side or front side of barrel 106 (not shown). A backside mount may be preferred, particularly when a concave surface of the leg cradles the barrel, to reduce tortional movement around the barrel 106.

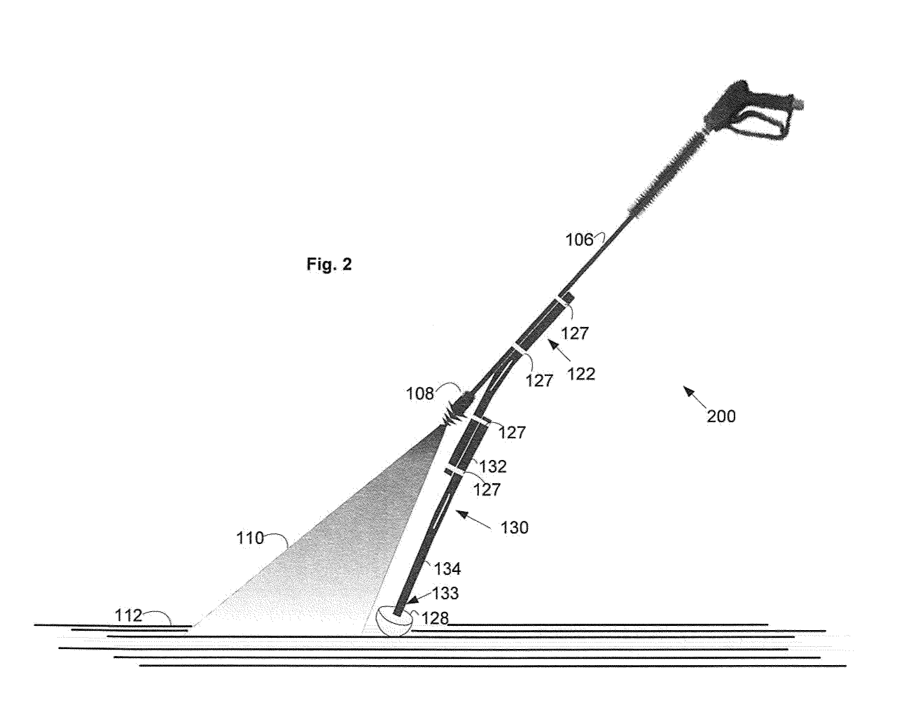

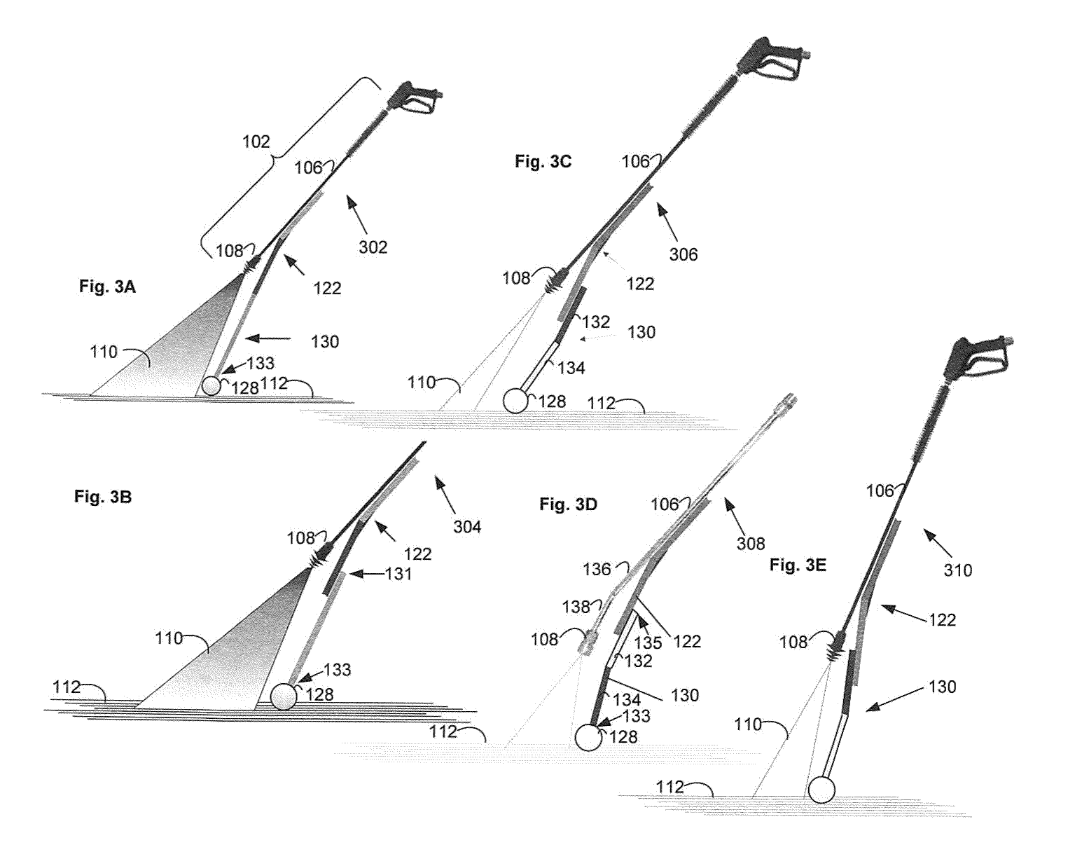

Preferably the foot 128 is removably secured to the free end 125 of the leg 122. The foot may be removably secured to the free end using a hook and loop fastener (see FIG. 6A). Other manners of removably and securely coupling may be used such as threaded fastener or snap fit fasteners or combinations of fasteners. The foot may be removable to accommodate an extension member as shown in FIGS. 2 and 3A to 3E.

To accommodate a connection of a spherical foot 128 (See FIG. 6A) to the free end 125 (or 123 when mounted as described above) the ends 125 or 123 may comprise a convex surface for securing to a portion of the foot. As described further below, the ends may include a portion of a threaded, snap fit or other fastener for securing to the foot (or an extension member).

FIG. 2 and FIGS. 3A and 3B and 3C to 3E are side views 200, 302, 304, 306, 308 and 310 of a crutch mounted for supporting a pressure washer wand having a nozzle in accordance with respective embodiments. In these embodiments crutch 101 comprises an elongate extension member or body 130 configured for removably securing to leg 122 about a free end 125. In the embodiment of FIGS. 3A and 3B the extension member 130 is substantially linear. In the embodiment of FIG. 2 and FIGS. 3C to 3E, extension member 130 is similarly configured to leg 122, comprising, a first elongate extension portion 132 and a second elongate extension portion 134 joined about respective ends in an angled relationship. Again this angle may be adjustable (though not shown). The extension member 130 may be configured similar to leg 122 (e.g. comprise a second leg) which may be mountable to the barrel as described below.

At least a portion of the extension body 130 may comprise at least one of a convex or concave surface for securing to a cooperative surface of leg 122 about a free end of the leg. Fasteners 127 may be used.

The extension body 130 may be further configured for removably securing to the foot 128 at end 133 thereof such as in alike manner described with reference to leg 122.

FIG. 3A shows an end to end coupling of leg 122 and extension body 130. It is noted that in FIG. 3A, the other portion 126 of leg 122 is mounted to the barrel 106 such that end 123 is free. FIG. 3B shows an overlapping coupling of extension portion 130 along a portion of leg 122 near free end 123. End 131 of body 130 may be convex to mate with end 123 or 125 of leg 122. Mounting along a portion of the leg 122 allows for height adjustment of the distance to support nozzle 108 from surface 112.

FIGS. 3C to 3E show the angled embodiment of extension body 130 in various mounted positions to show combination of angles to position the foot 128 around nozzle 108. Extension body 130 may be mounted to leg 122 on a side toward wand 102 as in FIG. 3E or on a side of leg 122 that is away from the wand as in FIGS. 3C and 3D. The extension body 130 may be configured with concave or convex surfaces to mate with opposite surfaces of the leg 122. See FIGS. 5A to 5F.

In each of the views of the embodiment comprising a leg 122 and an extension member 130, the leg is coupled to the barrel and the extension member to the leg 122. It will be apparent that in other embodiments (not shown), an extension member 130 may be coupled to barrel 106. Leg 122 may be coupled to a free end of such an extension member. In this way, foot 128 may always be coupled to the leg 122 and the extension member 130 need not be adapted to couple to a foot.

FIG. 4A is a side view showing a supported wand in three representative positions and

FIG. 4B is a front view showing a supported wand in three representative positions. The substantially rounded foot (in the embodiment of 4A a sphere and in the embodiment of 4B a hemisphere) permits multiple degrees of freedom to move the wand along lines 404 and 408 for instance and handle 104 about arcs 402 and 406 among others, not shown) when sweeping over the surface 112.

FIGS. 5A and 5B are respective side views of leg and extension body portions of the crutch in accordance with various embodiments. FIGS. 5C to 5D are cross-sectional views thereof along the respective lines shown in FIGS. 5A and 5B. Either or both of leg 122 and extension body 130 may comprise a brace 502 or 504 for stiffening the respective leg 122 or extension member 134. Such a brace may be integrally moulded with the respective portions 124/126 of the leg or 132/134 of the extension member.

In one embodiment, the respective angles adopted by the leg 122 and extension 130 may be 165° and 170° respectively. That is 15° or 10° respectively from horizontal (straight). When mounted together in one of the two mount relationships, the angles provide up to 25° (or 5°) from the longitudinal axis of the barrel 106 yet position the foot 128 around the nozzle 108 for supporting the nozzle in a spaced relationship from the surface 112 to be washed.

FIG. 5C shows the concave and convex surfaces that may be configured for opposite sides of portion 124 of leg 122. FIG. 5D shows the concave and convex surfaces that may be configured for opposite sides of portion 126 of leg 122. The size of these surfaces may differ to mount to different sized barrels. Extension body 130 may comprise different shaped surfaces as shown in FIGS. 5E and 5F to mate with the correspondingly sized but oppositely shaped surfaces of leg 122. A portion of a hook and loop fastener (e.g. opposing hook or loop portions) may be positioned along at least some of the concave and convex surfaces to engage with the other loop or hoop portion in an opposing convex or concave surface. These fastener portions may be mounted to (e.g. via adhesive) or moulded/formed as part of the surface. Though FIGS. 5C, 5D, 5E and 5F show portions of a hook and loop fastener mounted on the respective portions of the leg and extension, such portions of a hook and loop fastener are optional and other embodiments may or may not have same.

One or the other or both of the leg and extension may be marked with indicia (e.g. lines at regular intervals) (all not shown) to provide a repeatable position or measure for mounting the leg and/or extension. The indicia may be used to measure a distance that the nozzle is to be spaced from the surface to be washed.

FIGS. 6A and 6B are enlargements of respective embodiments of a foot portion 128 secured a leg potion 124 of the crutch 101. Foot 128 in this embodiment is a spherical ball such as a plastic ball. The ball 128 is coupled via hook and loop fastener 602 at end 123. The end 123 may be concave to mate with a portion of the surface of the ball 128.

Some surfaces 112 to be washed are more delicate than others. The surface of the crutch that contacts the surface to be washed may be soft so as to reduce scratching, marring, etc. A washing mitt 604 such as soft fabric may be secured over foot 128 (whether spherical or other shape) using a draw 606 or other closure (See FIGS. 6B and 7). In some embodiments, foot 128 may comprise a soft foam or a fuzzy surfaced ball (not shown).

FIG. 8, is an enlarged view of the embodiment of foot 128 not mounted to the crutch and comprising a hemispherical shaped body 802. In this configuration, rounded body 802 (hemisphere) has a central substantially cylindrical member 804 for coupling to an end of leg 122 or extension member 130. Though shown with a projecting member, body 802 may form a central channel or hole for receiving a portion of leg 122 or extension body 130 (not shown). The member 804 may define a portion of a push fit/snap fit connector or threaded fastener or other mechanism to couple the foot 128 to the crutch 101. Though both illustrated embodiments of foot 128 shown comprise uniformly rounded spherical or partial spherical bodies that are relatively easy to construct, other rounded shapes may be used.

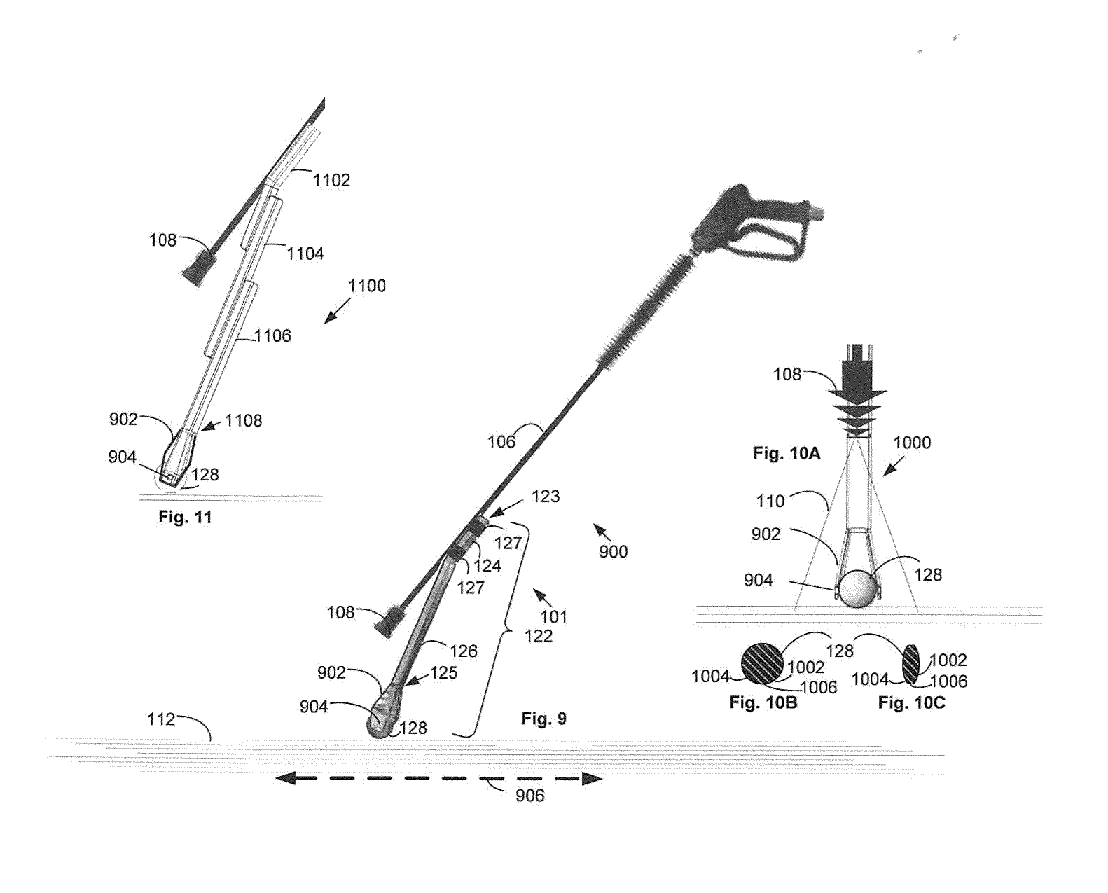

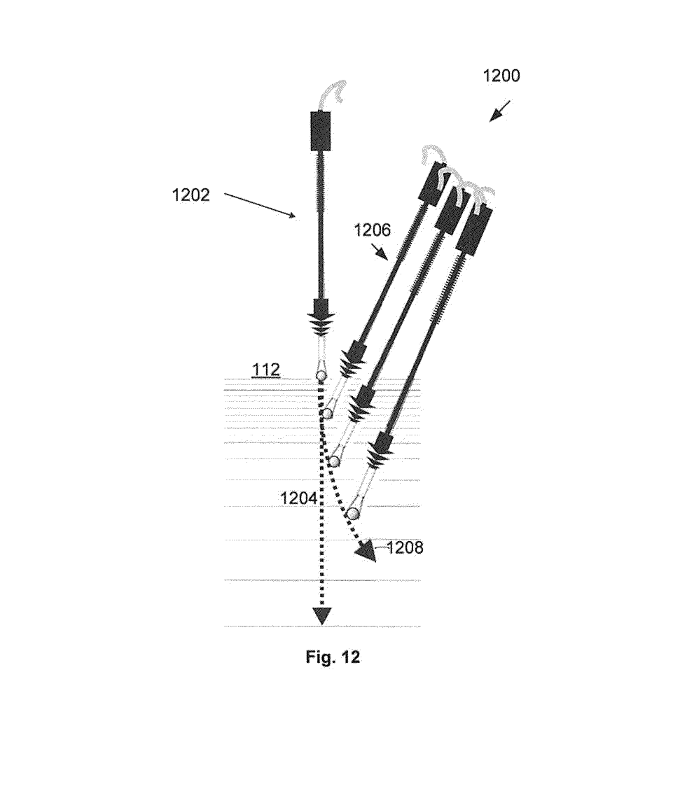

FIG. 9 is a side view 900 of a crutch mounted for supporting a pressure washer wand having a nozzle in accordance with a further embodiment. In this embodiment of crutch 101, foot 128 is mounted for rotation at the free end 125 of leg 122 to roll along the surface 112 to be washed. Body 902 at end 125 partially surrounds foot 128 and pin 904 couples the generally spherical foot to the body 902 for rotation. The axis of rotation is generally perpendicular to the longitudinal axis of the crutch at the free end. Another shaped foot may be used as shown in FIG. 10C. Foot 128 may rotate forwards or backwards along surface 112 when the wand is moved in the direction of arrow 906. When moved generally orthogonal to this direction, foot 128 may slide over surface 112. That is the foot may not rotate about its pin 904. However, as shown further in FIG. 12, a tilt applied to the wand to rotate the foot onto a side edge may be used to turn the direction of the nozzle along an arc-like path.

FIG. 10A illustrates a front view 1000 of a spherical shaped foot 128 mounted for rotation. FIG. 10B illustrates a cross-section of foot 128 of FIG. 10A showing rounded side edge 1002 and opposite edge 1004. The bottom of foot 128 in FIG. 10B is uniformly rounded as well. However, alternative shapes may be used. FIG. 10C shows an alternative shaped foot 128 in cross-section where its side edge 1002 is rounded but a narrow portion of its bottom 1004 is substantially flat. Rotation along the flat edge may move the wand in a straight line. Rotation upon a side of the foot moves the wand in a curve.

FIG. 11 illustrates a further side view 1100 of an embodiment in which the foot 128 is mounted for rotation. In this embodiment, leg 1102 is coupled to a first extension member 1104 which in turn is coupled to a second extension member 1106. Though not shown, in another mounting configuration, member 1106 may be coupled to leg 1102. A free end 1108 of extension member 1106 carries foot 128. Leg 1102 and members 1104 and 1106 may comprise mating concave/convex surfaces as previously described, for coupling to one another. A hook and eye fastener may be integrated into such mating surfaces.

As noted, FIG. 12 is a representation a view 1200 showing movement of the wand where the foot 128 is mounted for rotation. In a upright position 1202, the wand may be moved easily in a straight line 1204, running along substantially the bottom of the foot 128 on surface 112 as the foot rotates. In a tilted position 1206, the wand may be moved easily in a curved line 1208, running along a side edge of the foot as the foot 128 rotates.

Though not shown in FIG. 9, 10A, 11 or 12, the foot may be removably attached to a support leg or extension member, similar to the embodiments described earlier herein above. For example, body 902 (together with pin 904 and foot 128) may be detachable and re-attachable to an end of the leg or selected ones of the extension members using a snap fit, friction fit or threaded engagement for example.

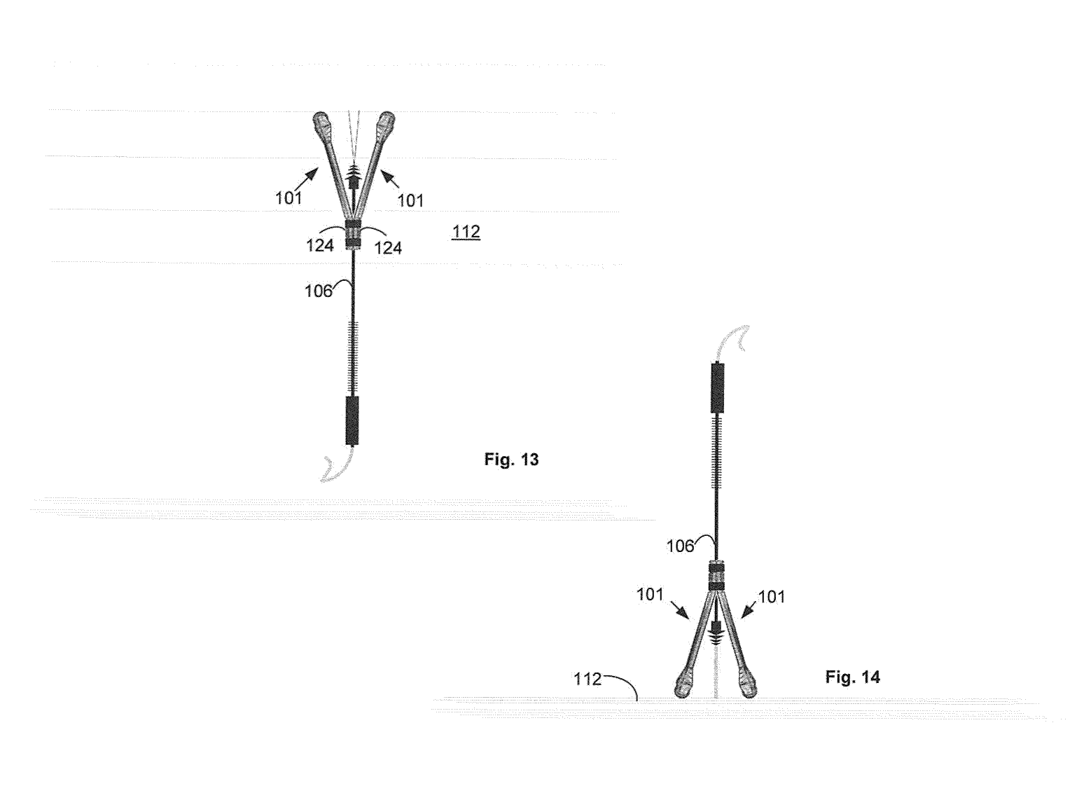

FIG. 13 shows a pair or crutches 101, each crutch previously described with reference to FIG. 9, mounted in opposing relationship and on sides of a barrel 106. FIG. 13 illustrates the assembly washing a vertical surface 112 such as siding on a wall. FIG. 14 illustrates the pair of assembled crutches on a washing wand washing a horizontal surface 112 such as a deck floor. In this assembly embodiment of FIGS. 13 and 14, the opposing crutches present respective feet in a facing relationship. The axes of the two feet are parallel to one another, and not aligned. Thus the assembly is particularly useful for a side to side power spraying motion providing enhanced stability. A person of skill will appreciate that the barrel facing surface of leg 124 may be sized to accommodate the facing relation to another leg 124 to securely mount the pair of legs 124 to barrel 106.

In some embodiments the crutch (particularly any leg, extension member or foot thereof) is comprised of materials such as polyvinyl chloride (PVC), polypropylene, polyethylene, nylon or other plastic polymers. Fiber reinforcements may be used to enhance the mechanical properties. In some embodiments, finely divided silica, carbon black, talc, mica, or calcium carbonate, as well as short fibers of a variety of materials, alone or in combination, may be incorporated as particulate fillers. These may be comprised of new or recycled materials. In some embodiments the crutch may be formed from wood, or metal (such as aluminum or stainless steel), or composites such as graphite or fiberglass.

As will be understood by persons of ordinary skill in the art, the pressure washer crutch shown in the various embodiments provides a strong physical “safe stop”, providing a minimum distance pivot point from the surface being cleaned. Used appropriately, the result is to protect the material being cleaned from being damaged by close up unintentional “proximity pressure” damage while providing the operator freedom of movement with the spray baton, moving in and out, back and forth, up and down including +/−360° angles. In the exemplary embodiments, the power washer crutch has no restricting mechanisms or assemblies that interface or interfere with the operation of the nozzle, or spray mechanism. The power washer crutch may comprise a cradle type connection to the power washer baton area substantially co-existing with the natural operation of the baton, and in no way interacting with or effecting its operation.

The crutch may comprise a kit for use with a separately purchased washer. For example, the kit may comprise a leg, one or more fasteners, a foot and optionally, an extension member. A consumer may assemble the crutch. The foot may be mounted to an end of the leg or optional extension member such as by snap fit or other fastener. The leg may be mounted to the barrel at a desired height and secured using one or more of the fasteners, for example, wrapping hook and loop strip(s) around the barrel in a tight configuration. Optionally, the extension member may be mounted and secured to a free end of the leg, if desired. In another embodiment, the extension member to the barrel and the leg to the extension member. The foot is mounted to the leg. A plurality of fasteners, such as hook and loop strip fasteners, may be used to mount the leg and extension member as described. The foot may snap fit in place to the end of one of the leg and/or extension member as applicable.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A crutch for supporting a pressure washer wand having a nozzle for washing a surface, said crutch comprising:
an elongate leg adapted to be removably secured along at least a portion of a barrel of the pressure washer wand, using at least one hook and loop fastener, the elongate leg comprising a concave surface for securing along a convex surface of the barrel, such that when secured, said leg comprises a free end extending away from the barrel; and
a rounded foot at the free end of the crutch for contacting the surface to be washed thereby to support the nozzle away from the surface.

2. The crutch of claim 1, wherein the concave surface of the leg is removably secured to the barrel at any point around the 360° surface of the barrel.

3. The crutch of claim 1 wherein, when secured to the barrel, the free end is canted away from a longitudinal axis of the barrel to avoid interfering with the nozzle.

4. The crutch of any one of the preceding claims wherein the leg comprises a first elongate portion and a second elongate portion joined about respective ends in an angled relationship.

5. The crutch of claim 4 wherein the angle is adjustable.

6. The crutch of claim 4 wherein the first elongate portion and the second elongate portion comprise respectively sized concave surfaces for securing along barrels having different sized convex surfaces.

7. The crutch of any one of the preceding claims wherein the foot is removably secured to the free end of the crutch.

8. The crutch of claim 7 wherein the foot is removably secured to the free end using a hook and loop fastener.

9. The crutch of claim 1 wherein the free end comprises a convex surface for securing to the foot.

10. The crutch of claim 1 comprising at least one elongate extension body to extend said leg, at least a portion of said at least one extension body configured for removably securing to said leg and whereby said foot is coupled to the at least one extension body.

11. The crutch of claim 10 wherein a one of the at least one extension body comprises a first elongate extension portion and a second elongate extension portion joined about respective ends in an angled relationship.

12. The crutch of claim 10 wherein a one of the at least one extension body comprises at least one of a convex or concave surface for securing to a cooperative surface of said leg.

13. The crutch of claim 1 wherein the foot comprises a contacting surface substantially rounded in all directions.

14. The crutch of claim 1 wherein the leg comprises a plastic body and one or more portions of hook and loop fasteners for matingly engaging one or more portions of hook and loop fasteners on said barrel.

15. The crutch of claim 14 wherein the hook and loop fasteners are integrally moulded in said plastic body.

16. The crutch of claim 1 wherein the foot comprises a plastic body and one or more portions of a hook and loop fastener for matingly engaging one or more portions of hook and loop fasteners on the free end of the leg.

17. The crutch of claim 1 wherein the foot is mounted for rotation to roll along the surface to be washed when in use.

18. A kit for configuring a crutch for supporting a pressure washer wand having a nozzle for washing a surface, said kit comprising:
a first elongate member adapted to be removably secured along at least a portion of a barrel of the pressure washer wand, the elongate member comprising a concave surface for securing along a convex surface of the barrel, such that when secured, said first elongate member comprises a free end extending away from the barrel;
a rounded foot at the free end of the first elongate member for contacting the surface to be washed thereby to support the nozzle away from the surface; and
a plurality of hook and loop fasteners, at least one of the fasteners for removably securing the first elongate member to the barrel.

19. The kit of claim 18 further comprising a second elongate member for coupling to extend the first elongate member, at least one of said first and said second elongate members configured for coupling to the barrel using at least one of the fasteners.

20. The kit of claim 18 wherein the foot is coupled for rotation to roll along the surface to be washed when in use.

21. A pressure washer assembly comprising:
a wand in fluid communication with a nozzle for delivering a spray;
a pump in fluid communication with the wand; and
a crutch comprising:
an elongate leg adapted to be removably secured along at least a portion of a barrel of the wand using at least one hook and loop fastener, the leg comprising a concave surface for securing along a convex surface of the barrel, such that when secured, said leg comprises a free end extending away from the barrel; and
a rounded foot at the free end of the crutch for contacting a surface to be washed thereby to support the nozzle away from the surface.

22. The pressure washer assembly of claim 21 wherein the foot is mounted for rotation to roll along the surface to be washed.

23. The pressure washer assembly of claim 21 further comprising a second crutch mounted in opposing relation to the crutch.

24. The pressure washer assembly of claim 23 wherein the crutch and second crutch are mounted to opposing sides of the barrel for side-to-side movement when washing.
